(19) United States
(12) Patent Application Publication
(10) Pub. No.: US 2022/0398938 A1
(43) Pub. Date: Dec. 15, 2022

(54) SYSTEMS AND METHODS FOR EVALUATING AND IMPROVING READING SKILLS IN REAL TIME

(71) Applicant: Edsoma, Inc., Weatherford, TX (US)

(72) Inventor: Kyle WALLGREN, Weatherford, TX (US)

(73) Assignee: Edsoma, Inc., Weatherford, TX (US)

(21) Appl. No.: 17/837,852

(22) Filed: Jun. 10, 2022

Related U.S. Application Data
(60) Provisional application No. 63/209,141, filed on Jun. 10, 2021.

(51) Int. Cl. G09B 17/00; G09B 5/02; G06F 15/02; G10L 15/26

(52) U.S. Cl. CPC G09B 17/003; G09B 5/02; G06F 15/0291; G10L 15/26

(57) ABSTRACT

Systems and methods for evaluating and improving reading skills in real time are disclosed. The method may include receiving a user selection of an electronic book in an application executing on a user device associated with a first user, opening the user selection of the electronic book in the application, initiating a video call or an audio call with a second user in the application, receiving from the first user one or more first spoken words associated with a first reading content of the electronic book, transcribing the one or more first spoken words to first text via the application, determining if the first text matches the first reading content of the electronic book, and transmitting the determination of whether the first text matches the first reading content of the electronic book to the first user and the second user.

### CROSS-REFERENCE TO RELATED PATENT APPLICATIONS

This application claims the benefit of U.S. Provisional Application No. 63/209,141, filed Jun. 10, 2021, the disclosure of which is incorporated by reference as set forth in full.

### TECHNICAL FIELD

This disclosure generally relates to education, and, in particular, to systems and methods for evaluating and improving reading skills in real time, for example, via a personal communications device.

### BACKGROUND

Learning to read is a critical development skill for children. In some instances, a child may be apart from a parent for a period of time. For example, a child may live apart from a parent as a result of a parent's military service, a parent's job that requires travel, or parents who are divorced. In these instances, it can be difficult for families to be engaged with each other daily in real time, and it may be difficult for a parent to assist a child in developing their reading skills.

In other circumstances, there is also a growing demand for children and adults to learn to read in a different language. However, finding in-person access to a foreign language teacher may be difficult, in part because many capable foreign language teachers may be located abroad or in communities that are remote from the children and adults desiring to learn the foreign language.

### BRIEF DESCRIPTION OF THE DRAWINGS

The drawings are provided for purposes of illustration only and merely depict example embodiments of the disclosure. The drawings are provided to facilitate understanding of the disclosure and shall not be deemed to limit the breadth, scope, or applicability of the disclosure. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a network diagram illustrating an example network environment for evaluating and improving reading skills in real time, in accordance with one or more example embodiments of the present disclosure.

FIG. 2 is a schematic diagram illustrating an example process for evaluating and improving reading skills in real time, in accordance with one or more example embodiments of the present disclosure.

FIG. 3 is a schematic diagram illustrating an example information flow when a system is evaluating and improving reading skills in real time, in accordance with one or more example embodiments of the present disclosure.

FIG. 4 is a schematic diagram illustrating an example system architecture for evaluating and improving reading skills in real time, in accordance with one or more example embodiments of the present disclosure.

FIG. 5 is a schematic diagram illustrating an example service layer of the system architecture depicted in FIG. 4, in accordance with one or more example embodiments of the present disclosure.

FIG. 6 is a schematic diagram illustrating an example presentation layer and an example business layer of the system architecture depicted in FIG. 4, in accordance with one or more example embodiments of the present disclosure.

FIG. 7 is a schematic diagram illustrating an example data layer and an example core layer of the system architecture depicted in FIG. 4, in accordance with one or more example embodiments of the present disclosure.

FIG. 8 is a schematic diagram illustrating an example set of libraries and interfaces of the system architecture depicted in FIG. 4, in accordance with one or more example embodiments of the present disclosure.

FIG. 9 is a block diagram of an example machine upon which any of one or more techniques (e.g., methods) may be performed, in accordance with one or more example embodiments of the present disclosure.

FIGS. 10A-E depict example display screen outputs generated by an application for evaluating and improving reading skills in real time, in accordance with one or more example embodiments of the present disclosure.

FIGS. 11A-E depict example display screen outputs generated by an application for evaluating and improving reading skills in real time, in accordance with one or more example embodiments of the present disclosure.

FIGS. 12A-E depict example display screen outputs generated by an application for evaluating and improving reading skills in real time, in accordance with one or more example embodiments of the present disclosure.

FIGS. 13A-E depict example display screen outputs generated by an application for evaluating and improving reading skills in real time, in accordance with one or more example embodiments of the present disclosure.

FIGS. 14A-E depict example display screen outputs generated by an application for evaluating and improving reading skills in real time, in accordance with one or more example embodiments of the present disclosure.

FIGS. 15A-E depict example display screen outputs generated by an application for evaluating and improving reading skills in real time, in accordance with one or more example embodiments of the present disclosure.

FIGS. 16A-E depict example display screen outputs generated by an application for evaluating and improving reading skills in real time, in accordance with one or more example embodiments of the present disclosure.

FIGS. 17A-E depict example display screen outputs generated by an application for evaluating and improving reading skills in real time, in accordance with one or more example embodiments of the present disclosure.

FIGS. 18A-D depict example display screen outputs generated by an application for evaluating and improving reading skills in real time, in accordance with one or more example embodiments of the present disclosure.

FIGS. 19A-D depict example display screen outputs generated by an application for evaluating and improving reading skills in real time, in accordance with one or more example embodiments of the present disclosure.

FIG. 20 is a flow chart of an example method for evaluating and improving reading skills in real time, in accordance with one or more example embodiments of the present disclosure.

This disclosure will now provide a more detailed and specific description that will refer to the accompanying drawings. The drawings and specific descriptions of the drawings, as well as any specific or other embodiments discussed, are intended to be read in conjunction with the entirety of this disclosure.

### DETAILED DESCRIPTION

This disclosure relates to systems and methods evaluating and improving reading skills in real time in accordance with certain embodiments of the disclosure. In one embodiment, a system for evaluating and improving reading skills in real time can be provided. In another embodiment, a method for evaluating and improving reading skills in real time can be provided.

In one or more embodiments, the method for evaluating and improving reading skills in real-time may include receiving a user selection of an electronic book in an application executing on a user device associated with a first user, opening the user selection of the electronic book in the application, initiating a video call or an audio call with a second user in the application, receiving from the first user one or more first spoken words associated with a first reading content of the electronic book, transcribing the one or more first spoken words to first text via the application, determining if the first text matches the first reading content of the electronic book, and transmitting the determination of whether the first text matches the first reading content of the electronic book to the first user and the second user.

In one or more embodiments, the first user is one of a child or a language student, and wherein the second user is one of a parent, a teacher, or a language-fluent person.

In one or more embodiments, the method may include receiving from the first user one or more second spoken words associated with a second reading content of the electronic book, transcribing the one or more second spoken words to second text via the application, determining if the second text matches the second reading content of the electronic book, and transmitting the determination of whether the second text matches the second reading content of the electronic book to the first user and the second user.

In one or more embodiments, the method may include initiating the video call or the audio call with the second user and a third user via the application.

In one or more embodiments, the application is configured to highlight the first reading content of the electronic book as the one or more first spoken words are received from the first user.

In one or more embodiments, receiving a user selection of the electronic book in the application further includes requesting a list of electronic books via a search function in the application, receiving a list of electronic books via the search function, and selecting the electronic book from the list of electronic books. In one or more embodiments, the search function is configured to allow the first user or the second user to search for the list of electronic books by at least one of a book title, an author name, or a keyword.

In one or more embodiments, a system for evaluating and improving reading skills in real-time may include a user device associated with a first user executing an application configured to receive a user selection of an electronic book, open the user selection of the electronic book, initiate a video call or an audio call with a second user, receive from the first user one or more first spoken words associated with a first reading content of the electronic book, transcribe the one or more first spoken words to first text, determine if the first text matches the first reading content of the electronic book, and transmit the determination of whether the first text matches the first reading content of the electronic book to the first user and the second user.

In one or more embodiments, the first user is one of a child or a language student, and wherein the second user is one of a parent, a teacher, or a language-fluent person.

In one or more embodiments, the application is further configured to receive from the first user one or more second spoken words associated with a second reading content of the electronic book, transcribe the one or more second spoken words to second text, determine if the second text matches the second reading content of the electronic book, and transmit the determination of whether the second text matches the second reading content of the electronic book to the first user and the second user.

In one or more embodiments, the application is further configured to initiate the video call or the audio call with the second user and a third user.

In one or more embodiments, the application is further configured to highlight the first reading content of the electronic book as the one or more first spoken words are received from the first user.

In one or more embodiments, the application is further configured to request a list of electronic books via a search function, receive a list of electronic books via the search function, and select the electronic book from the list of electronic books. In one or more embodiments, the search function is configured to allow the first user or the second user to search for the list of electronic books by at least one of a book title, an author name, or a keyword.

In one or more embodiments, a device may comprise a memory that stores computer-executable instructions, and a processor configured to access the memory and execute the computer-executable instructions to at least receive a user selection of an electronic book in an application associated with a first user, open the user selection of the electronic book in the application, initiate a video call or an audio call with a second user in the application, receive from the first user one or more first spoken words associated with a first reading content of the electronic book, transcribe the one or more first spoken words to first text via the application, determine if the first text matches the first reading content of the electronic book, and transmit the determination of whether the first text matches the first reading content of the electronic book to the first user and the second user.

In one or more embodiments, the first user is one of a child or a language student, and wherein the second user is one of a parent, a teacher, or a language-fluent person.

In one or more embodiments, the processor is further configured to access the memory and execute additional computer-executable instructions to at least receive from the first user one or more second spoken words associated with a second reading content of the electronic book transcribe the one or more second spoken words to second text via the application, determine if the second text matches the second reading content of the electronic book, and transmit the determination of whether the second text matches the second reading content of the electronic book to the first user and the second user.

In one or more embodiments, the processor is further configured to access the memory and execute additional computer-executable instructions to at least initiate the video call or the audio call with the second user and a third user via the application.

In one or more embodiments, the application is configured to highlight the first reading content of the electronic book as the one or more first spoken words are received from the first user.

In one or more embodiments, the processor is further configured to access the memory and execute additional computer-executable instructions to at least request a list of electronic books via a search function in the application, receive a list of electronic books via the search function, and select the electronic book from the list of electronic books.

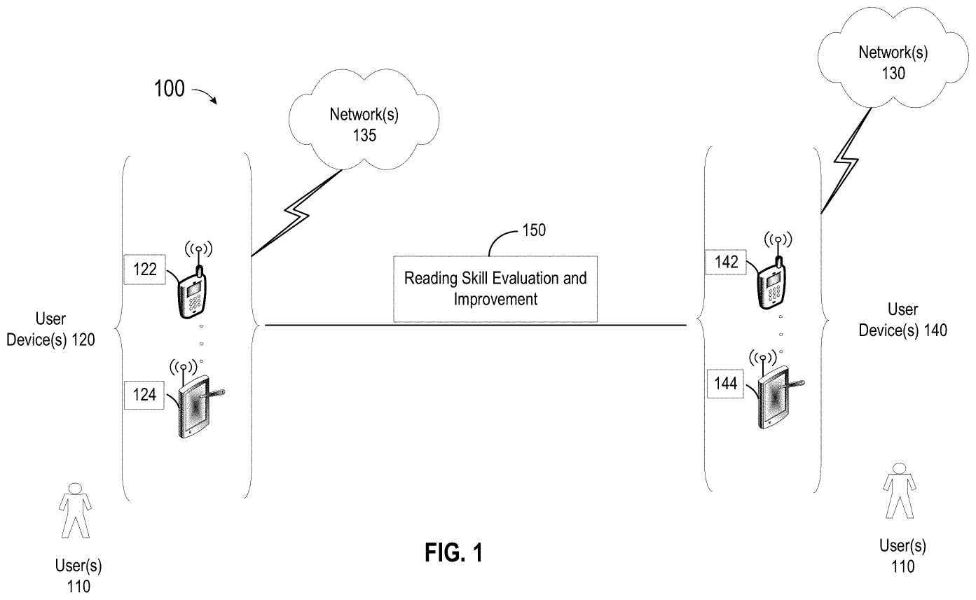

Turning to the figures, FIG. 1 is a network diagram illustrating an example network environment 100 for evaluating and improving reading skills in real time, according to some example embodiments of the present disclosure. The network environment 100 can include one or more first user device(s) 120 (e.g., 122 or 124), which may communicate in accordance with wireless standards, such as Bluetooth and the IEEE 802.11 communication standards, over network(s) 135. The one or more first user device(s) 120 (e.g., 122 or 124) may be configured to communicate with one or more second user device(s) 140 (e.g., 142 or 144), which may communicate in accordance with wireless standards, such as Bluetooth and the IEEE 802.11 communication standards, over network(s) 130.

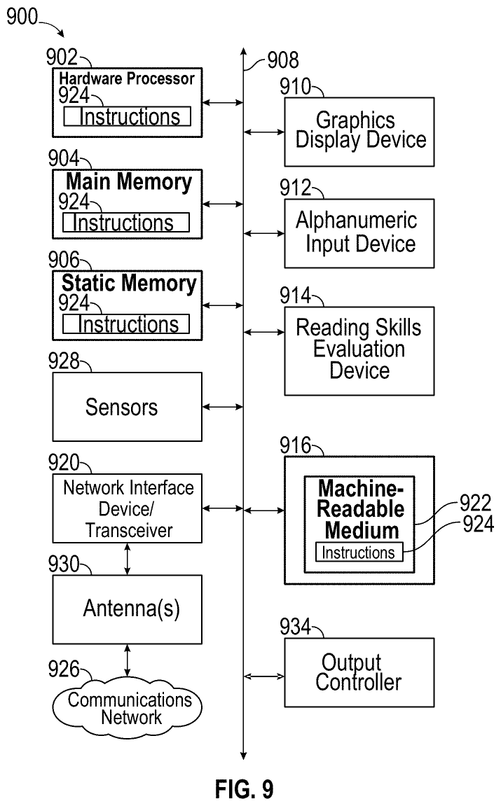

In some embodiments, the one or more first user device(s) 120 and the one or more second user device(s) 140 can include one or more computer systems similar to that of the example machine of FIG. 9. One or more illustrative user device(s) 120 and 140 may be operable by one or more user(s) 110. The one or more first user device(s) 120 (e.g., 122 or 124) and the one or more second user device(s) 140 (e.g., 142 or 144) may include any suitable processor-driven user device including, but not limited to, a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an A/V device, a flat panel display, a personal media player (PMP), a gaming device, a smartphone, a television, and so forth.

Any of the first user device(s) 120 (e.g., 122 or 124) and any of the second user device(s) 140 (e.g., 142 or 144) may be configured to communicate with each other and/or any other component of the network environment 100 directly and/or via the one or more communications network(s) 130 and 135, wirelessly or wired.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, cell phones, desktop computers, laptop computers, tablet computers, personal digital assistants (PDAs), and other devices that are equipped with an addressable communications interface for communicating with the IoT network.

Any of the communications network(s) 130 and 135 may include, but not be limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications network(s) 130 and 135 may have any suitable communication range associated therewith and may include, for example, global networks (e.g., the Internet), metropolitan area networks (MANs), wide area networks (WANs), local area networks (LANs), or personal area networks (PANs). In addition, any of the communications network(s) 130 and 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the first user device(s) 120 (e.g., 122 or 124) and any of the second user device(s) 140 (e.g., 142 or 144) may include one or more communications antennas. Communications antennas may be any suitable type of antenna corresponding to the communications protocols used by the first user device(s) 120 and the second user device(s) 140. Some non-limiting examples of suitable communications antennas include Bluetooth antennas, Wi-Fi antennas, IEEE 802.11 family of standards compatible antennas, directional antennas, non-directional antennas, dipole antennas, folded dipole antennas, patch antennas, MIMO antennas, or the like. The communications antenna may be communicatively coupled to a radio component to transmit and/or receive signals, such as communications signals, to and/or from the first user device(s) 120 (e.g., 122 or 124) and the second user device(s) 140 (e.g., 142 or 144).

Any of the first user device(s) 120 (e.g., 122 or 124) and any of the second user device(s) 140 (e.g., 142 or 144) may include any suitable radio and/or transceiver for transmitting and/or receiving radio frequency (RF) signals in the bandwidth and/or channels corresponding to the communications protocols utilized by any of the first user device(s) 120 and the second user device(s) 140 to communicate with each other. The radio components may include hardware and/or software to modulate and/or demodulate communications signals according to pre-established transmission protocols. The radio components may further have hardware and/or software instructions to communicate via one or more Bluetooth, Wi-Fi, and/or Wi-Fi Direct protocols, as standardized by the Bluetooth and the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad, 802.11ay). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In some embodiments, and with reference to FIG. 1, the one or more first user device(s) 120 (e.g., 122 or 124) may facilitate reading skill evaluation and improvement 150 with the one or more second user device(s) 140 (e.g., 142 or 144). For example, a first user device 120 may evaluate a reading skill associated with a user 110 associated with the first user device 120, and may provide suggestions as to improvements associated with the user's 110 reading skills. This may occur while the first user device 120 is connected to a second user device 140 via a reading session hosted by an application that is downloaded to the first user device 120 and the second user device 140.

It is understood that the above descriptions are for purposes of illustration and are not meant to be limiting.

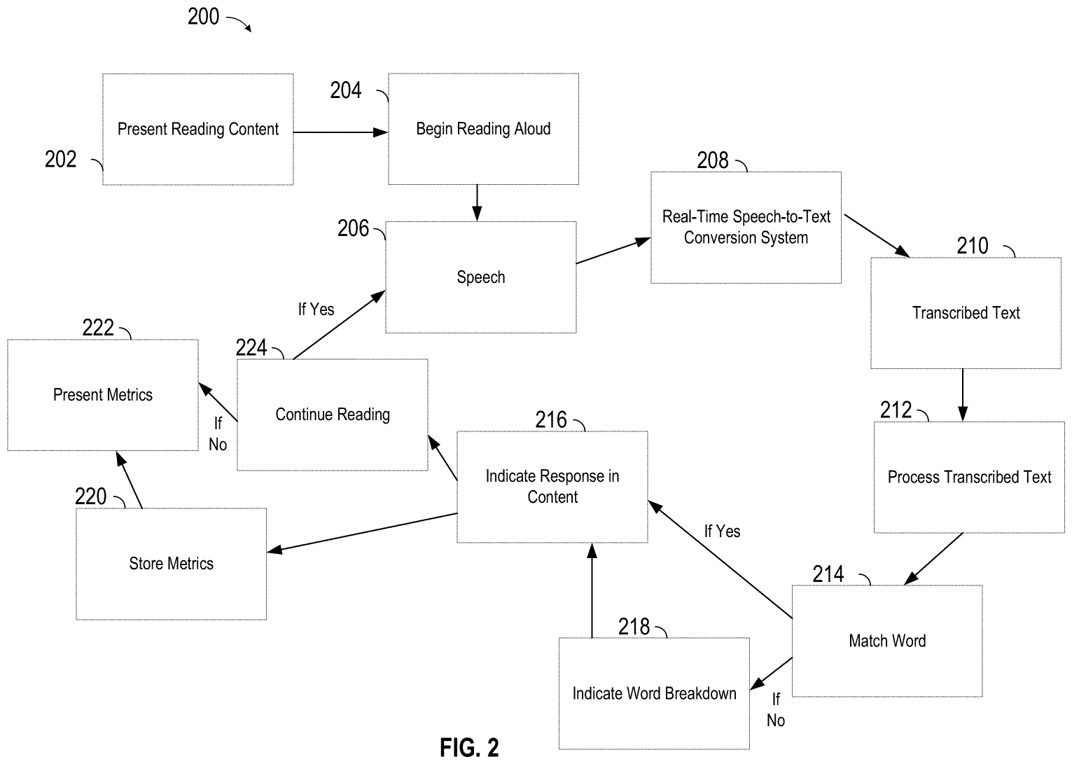

FIG. 2 is a schematic diagram illustrating an example process 200 for evaluating and improving reading skills in real time, according to some example embodiments of the present disclosure.

In some embodiments, at step 202, the process 200 for evaluating and improving reading skills in real time may include presenting reading content at more than one user device. The reading content may be presented at a child's user device or a student's user device, where the student may be a child or an adult. The same reading content may be further presented at another user device. The other user device may be a parent's user device, another adult's user device, a teacher's user device, or another user device associated with a user who is assisting the child or student with developing his or her reading skills.

In some embodiments, at step 204, the child or student may begin to read aloud the reading content that is presented at his or her user device. In some embodiments, at step 206, the child's user device or the student's user device may listen to the speech of the child or the student. In some embodiments, at step 208, the child's user device or the student's user device may apply a real-time speech-to-text conversion system to the speech of the child or the student. In some embodiments, at step 210, the real-time speech-to-text conversion system may produce a transcribed text based on the speech of the child or the student.

In some embodiments, at step 212, the transcribed text may be processed and compared to the reading content that is presented at the child's user device or the student's user device. In some embodiments, at step 214, it may be determined whether the transcribed text matches the word contained in the reading content that is presented at the child's user device or the student's user device. Matching may involve evaluating the child's or student's pronunciation relative to the pronunciation as intended by the author. In some embodiments, at step 216, if the transcribed text is determined to match the word contained in the reading content, a response may be indicated at both user devices (the child's user device or the student's user device, and the parent's user device, another adult's user device, or a teacher's user device, etc.) in the reading content, where the response may indicate a successful match between the transcribed text and the word contained in the reading content. In some embodiments, at step 218, if the transcribed text is determined to not match the word contained in the reading content, the word may be highlighted (for example, in red), and a breakdown of the word may be indicated in order to assist the child or student with reading the word if the user has attempted the word multiple times in error. In some embodiments, the process 200 may then return to step 216, where the response may be indicated at both user devices (the child's user device or the student's user device, and the parent's user device, another adult's user device, or a teacher's user device, etc.) in the reading content, where the response may indicate a word breakdown associated with the word contained in the reading content.

In some embodiments, steps 212, 214, 216, and 218 may be executed one word at a time. In other embodiments, steps 212, 214, 216, and 218 may be executed multiple words at a time.

In some embodiments, at step 220, metrics associated with the child's or the student's reading skills may be stored. The metrics may be based on whether the transcribed text matches the words presented in the reading content at the child's user device or the student's user device. For example, a word that is read in error may be identified as an error and stored in the user's record to be used for scoring and other analytics. The metrics may further include data regarding content selection, content management, reading progress for each book, and date and time information associated with the user's use of the application. In some embodiments, at step 222, the metrics associated with the user's or the student's reading skills may be presented at the various user devices, including the child's or the student's user device, and/or the parent's or adult's or teacher's user device. In some embodiments, at step 224, after the response is indicated in the reading content, the child or the student may continue reading. In such embodiments, the user device may continue to listen to the child or the student's speech. In other embodiments, if the child or the student opts to not continue reading, the process 200 may move to step 222, where the metrics associated with the user's or the student's reading skills may be presented at the various user devices, including the child's or the student's user device, and/or the parent's or adult's or teacher's user device.

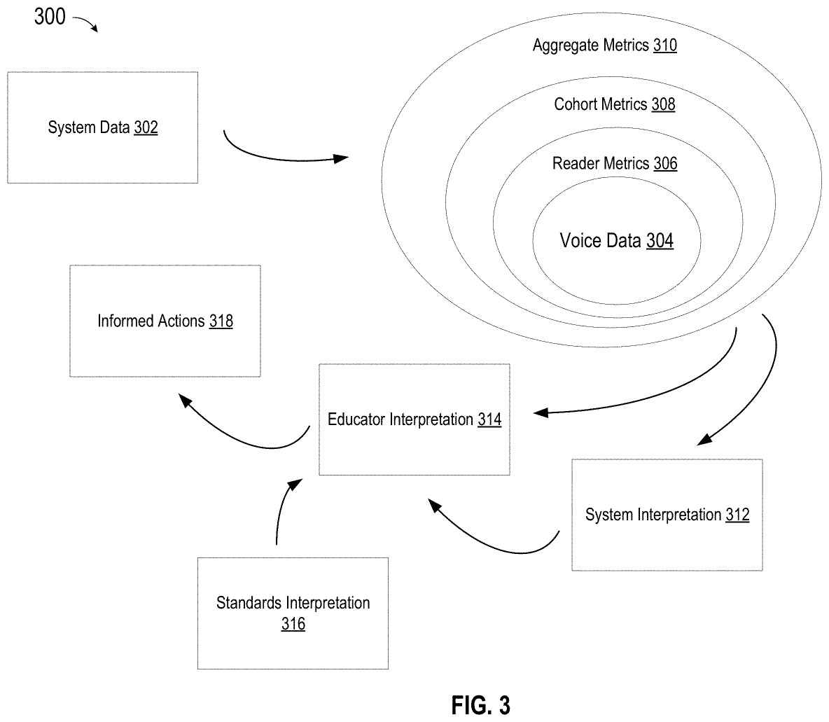

FIG. 3 is a schematic diagram illustrating an example information flow 300 when a system is evaluating and improving reading skills in real time, according to some example embodiments of the present disclosure. In some embodiments, system data 302 may be first received. System data 302 may include the reading content being presented at each user device. The system data 302 may then be used in combination with voice data 304, reader metrics 306, cohort metrics 308, and aggregate metrics 310 in order to evaluate and improve the reading skills of the child or student. The voice data 304 may refer to the speech generated by the child or student while reading the reading content out loud, and the voice data 304 may further refer to the transcribed text generated by a real-time speech-to-text conversion system based on the speech. The reader metrics 306 may refer to metrics associated with the child or student. The cohort metrics 308 may refer to metrics associated with a group of children or students of a similar demographic. For example, the cohort metrics 308 may refer to metrics associated with a group of children at a certain age or students of a certain language proficiency level. The aggregate metrics 310 may refer to metrics associated with all users of the system for evaluating and improving reading skills in real time.

In some embodiments, the voice data 304, reader metrics 306, cohort metrics 308, and aggregate metrics 310 may be used for system interpretation 312. For example, system interpretation 312 may include the user device being configured to evaluate the child's or student's reading levels based on the voice data 304, the reader metrics 306, the cohort metrics 308, and the aggregate metrics 310. In some embodiments, the voice data 304, reader metrics 306, cohort metrics 308, and aggregate metrics 310 may be used for educator interpretation 314, where a teacher, parent, or adult may evaluate the child's or student's reading levels based on the voice data 304, the reader metrics 306, the cohort metrics 308 (e.g., metrics for each grade level, metrics for each educator, metrics for each school/district/region/state, etc.), and the aggregate metrics 310. In certain embodiments, the educator interpretation 314 may rely at least in part on the system interpretation 312. In certain embodiments, the educator interpretation 314 may rely at least in part on standards interpretation 316, which may account for other standards that may be used to assess reading skills, including but not limited to proper pronunciation, proper enunciation, proper spelling, reading speed, reading comprehension, word recognition, and/or other reading metrics (e.g., for the user's grade level) as defined by various scoring standards. In some embodiments, the educator interpretation 314 may be further used to provide educator notes and comments to the user generate informed actions 318, which may include recommendations and/or suggested improvements in order for the child or student to improve his or her reading skills.

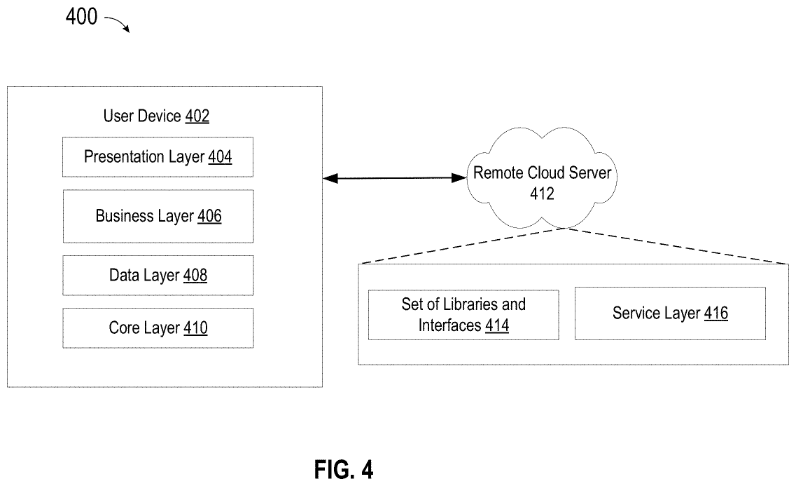

FIG. 4 is a schematic diagram illustrating an example system architecture 400 for evaluating and improving reading skills in real time, according to some example embodiments of the present disclosure. In some embodiments, the system architecture 400 may include at least one user device 402. The at least one user device 402 may include a presentation layer 404, a business layer 406, a data layer 408, and a core layer 410. In some embodiments, more than one user device 402 may be included in the system architecture 400. Each user device 402 may include its own presentation layer 404, business layer 406, data layer 408, and core layer 410. In some embodiments, each user device 402 may be configured to establish a secure connection between the respective user device 402 and a remote cloud server 412. The remote cloud server 412 may include a set of libraries and interfaces 414 stored at the remote cloud server 412 and a service layer 416.

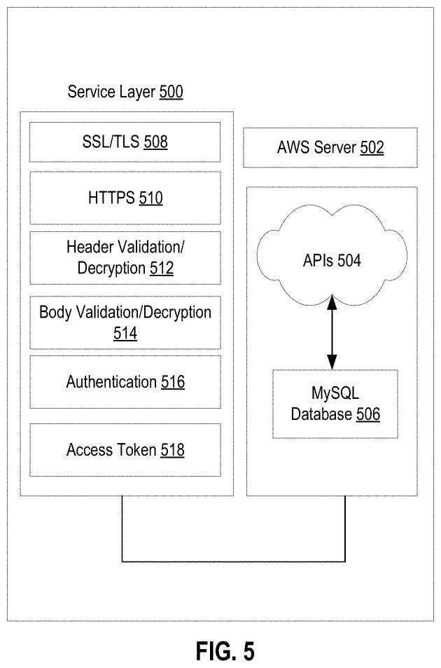

FIG. 5 is a schematic diagram illustrating an example service layer 500, according to some example embodiments of the present disclosure. For example, the service layer 500 may be the service layer 416 depicted in the system architecture 400 in FIG. 4. In some embodiments, the service layer 500 may be connected to a remote server, for example, an AWS server 502. The AWS server 502 may use Application Programming Interfaces (APIs) 504 to communicate requests to and receive information from a MySQL database 506. The service layer 500 may further improve the security of communications by including Secure Socket Layer/Transport Layer Security (SSL/TLS) protocols 508, Hypertext Transfer Protocol Secure (HTTPS) protocols 510, header validation and decryption capabilities 512, body validation and decryption capabilities 514, authentication capabilities 516, and access token usage 518.

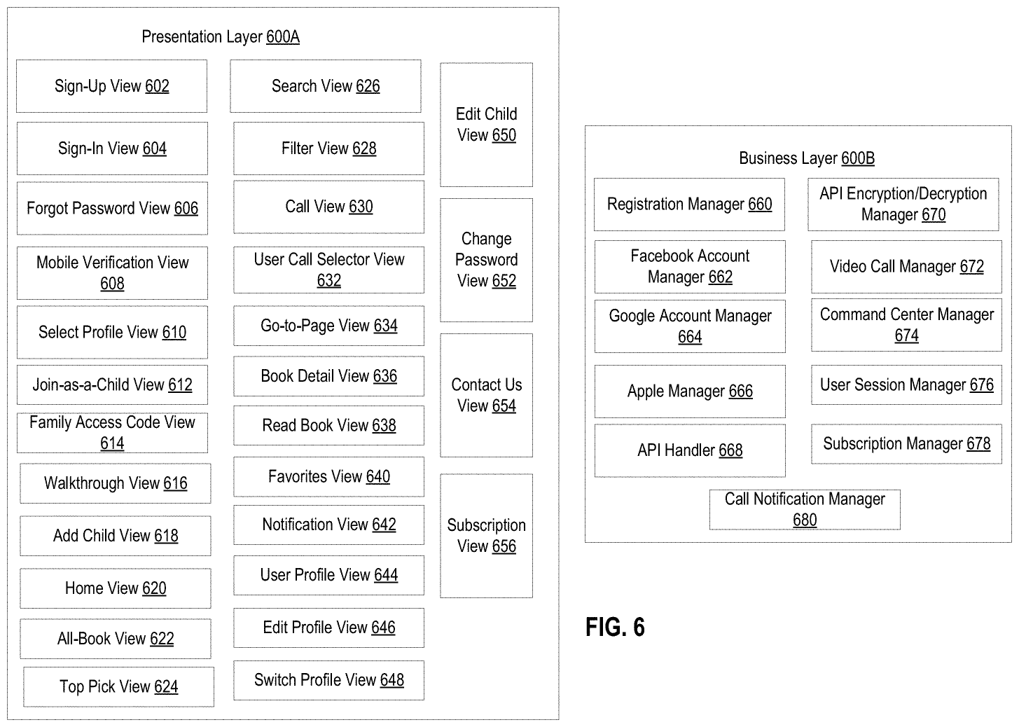

FIG. 6 is a schematic diagram illustrating an example presentation layer 600A and an example business layer 600B, according to some example embodiments of the present disclosure. For example, the presentation layer 600A may be the presentation layer 404 depicted in the system architecture 400 in FIG. 4, and the business layer 600B may be the business layer 406 depicted in the system architecture 400 in FIG. 4.

In some embodiments, the presentation layer 600A may include the following views at a display interface of a user device: a sign-up view 602 (to allow users to create accounts for accessing the system for evaluating and improving reading skills), a sign-in view 604 (to allow users to log in to their accounts), a forgot password view 606 (to allow users to recover a password for their accounts), a mobile verification view 608 (to verify users before allowing them to log in to their accounts), a select profile view 610 (to allow users to choose their profile before accessing their accounts), a join-as-a-child view 612 (to allow children to create and access accounts that are tied to a parent or other adult), a family access code view 614 (to allow parents and children to connect to a single reading session via an access code), a walkthrough view 616 (to allow users to receive a guided tour of the graphical user interface (GUI)), an add child view 618 (to allow parents or other adults to connect a child to their accounts), a home view 620 (to allow users to access a home screen after logging in to their accounts), an all-book view 622 (to allow users to view all books that are available to them), a top pick view 624 (to allow users to view currently popular books), a search view 626 (to allow users to search for a particular book), a filter view 628 (to allow users to view a subset of books based on filtering criteria), a call view 630 (to allow users to initiate a call through the system), a user call selector view 632 (to allow users to select a call recipient through the system, such as a parent or a teacher), a go-to-page view 634 (to allow users to select a particular page within a book for viewing), a book detail view 636 (to allow users to obtain more information about a particular book), a read book view 638 (to allow users to peruse reading content within a book), a favorites view 640 (to allow users to customize a list of favorite books within their accounts), a notification view 642 (to allow users to receive and view notifications), a user profile view 644 (to allow users to view their profiles), an edit profile view 646 (to allow users to edit their profiles), a switch profile view 648 (to allow users to change between profiles), an edit child profile view 650 (to allow parents or adults to edit a profile associated with a child connected to their accounts), a change password view 652 (to allow users to switch passwords), a contact us view 654 (to allow users to reach out to system developers with questions and/or comments), a subscription view 656 (to allow users to view their subscription statuses), and an about us view 658 (to allow users to obtain more information about the system developers).

In some embodiments, the business layer 600B may include a registration manager 660 (for managing user registrations), a Facebook account manager 662 (for connecting users' Facebook accounts with user registrations), a Google account manager 664 (for connecting users' Google accounts with user registrations), an Apple manager 666 (for connecting users' Apple accounts with user registrations), an API handler 668 (for managing communications), an API encryption and decryption manager 670 (for managing communications), a video call manager 672 (for managing video calls during reading sessions), a command center manager 674 (for managing system operations), a user session manager 676 (for managing reading sessions), a subscription manager 678 (for managing user subscriptions), and a call notification manager 680 (for managing call notifications between users).

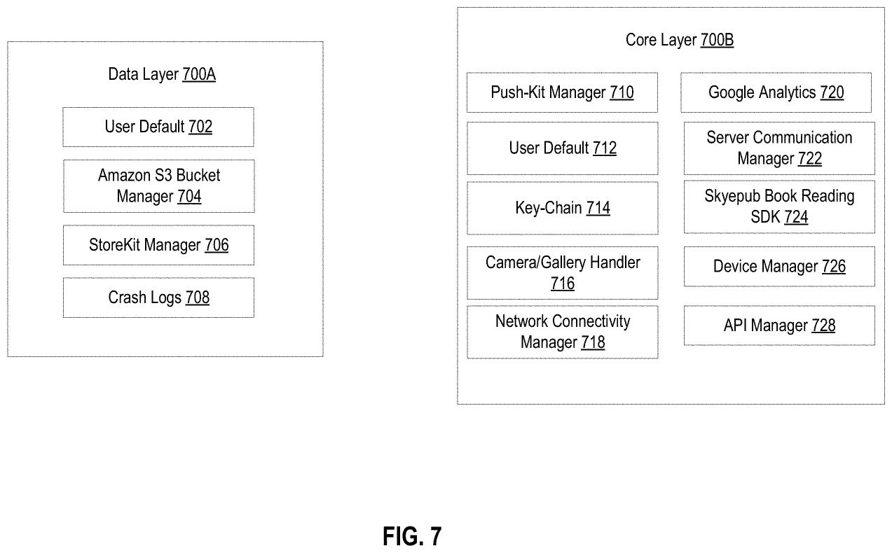

FIG. 7 is a schematic diagram illustrating an example data layer 700A and an example core layer 700B, according to some example embodiments of the present disclosure. For example, the data layer 700A may be the data layer 408 depicted in the system architecture 400 in FIG. 4, and the core layer 700B may be the core layer 410 depicted in the system architecture 400 in FIG. 4.

In some embodiments, the data layer 700A may include a user default 702 (for managing default user settings), an Amazon S3 bucket manager 704 (for managing objects stored within buckets associated with the user's account), a StoreKit manager 706 (for managing user purchases within the system), and crash logs 708 (for recording historical data associated with crashes of the system).

In some embodiments, the core layer 700B may include a push-kit manager 710 (for managing notifications), a user default 712 (for managing default user settings), a key-chain 714 (for local storage of data), a camera/gallery handler 716 (for managing images and/or videos associated with the system), a network connectivity manager 718 (for managing wireless or wired connectivity of the system), Google analytics 720 (for analyzing data associated with users), a server communication manager 722 (for managing communications), a Skyepub book reading SDK 724 (for managing and facilitating EPUB files), a device manager 726 (for managing user devices), and an API manager 728 (for managing communications).

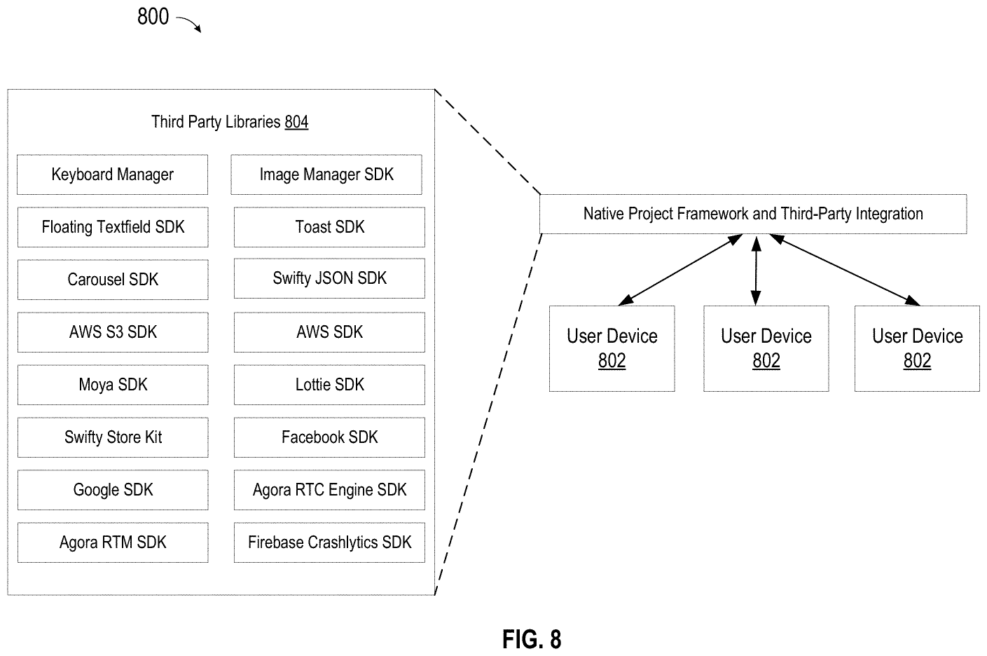

FIG. 8 is a schematic diagram illustrating an example set of libraries and interfaces 800, according to some example embodiments of the present disclosure. For example, the set of libraries and interfaces 800 may be the set of libraries and interfaces 414 depicted in the system architecture 400 in FIG. 4. In some embodiments, the set of libraries and interfaces 800 may be initialized and loaded. When each user device 802 loads an application containing the system for evaluating and improving reading skills in real time, a native framework may be used to render the application and third party libraries 804 may be integrated. The third party libraries 804 may include a keyboard manager, an image manager SDK, a floating textfield SDK, a Toast SDK, a Carousel SDK, a Swifty JSON SDK, an AWS S3 SDK, an AWS SDK, a Moya SDK, a Lottie SDK, a Swift Store Kit, a Facebook SDK, a Google SDK, an Agora RTM SDK, an Aora RTC Engine SDK, a Firebase Crashlytics SDK, and any other library.

FIG. 9 depicts a block diagram of an example machine 900 upon which any of one or more techniques (e.g., methods) may be performed, according to some example embodiments of the present disclosure. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. In some embodiments, the machine 900 may be a first user device 120 or a second user device 140, as depicted in FIG. 1. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a graphics display device 910, an alphanumeric input device 912 (e.g., a keyboard), and a reading skills evaluation device 914. In an example, the graphics display device 910 and the alphanumeric input device 912 may be a touch screen display. The machine 900 may additionally include a storage device (i.e., drive unit) 916, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 916 may include a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee®, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

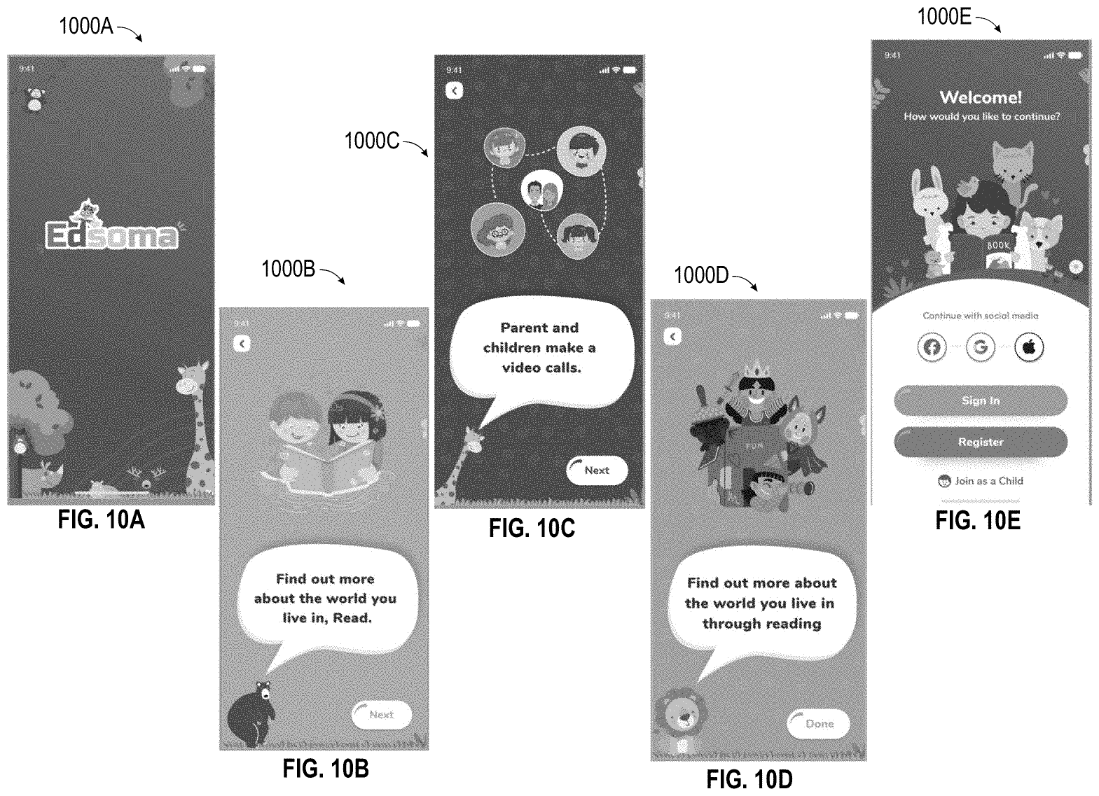

FIGS. 10A-E depict example display screen outputs 1000A-E generated by an application for evaluating and improving reading skills in real time, according to some example embodiments of the present disclosure.

In some embodiments, when the application is opened by a user on a user device (e.g., a mobile device), a logo may be displayed on the display screen. The display screen may then output a transition to a start screen after several seconds. In some embodiments, as displayed in FIG. 10A, the initial screen display 1000A when the application is opened may include a variety of graphics, for example, the “Edsoma” logo displayed in the middle of the display screen.

In some embodiments, the start screen may include a walkthrough output including multiple display screen outputs, each with an image at the top of the display screen and a tagline at the bottom of the display screen. The walkthrough output may describe features of the application. Because the walkthrough output may include more than one display screen output, the user may transition the display screen from one display screen output to another display screen output by tapping a finger on the display screen, swiping a finger on the display screen, or pressing a physical or displayed button on the user device. In one embodiment, as depicted in FIG. 10B, a first display screen output 1000B of the walkthrough output may include a graphic of two people reading, with the tagline “Find out more about the world you live in, Read.” displayed below the graphic. In this embodiment, pressing the “Next” button on the display screen may bring the user to the second display screen output 1000C of the walkthrough output, as depicted in FIG. 10C, which may include a graphic of several people connected by a dotted line and the tagline “Parent and children make a conference calls” displayed below the graphic. Further, pressing the “Next” button on the display screen may then bring the user to the third display screen output 1000D of the walkthrough output, as depicted in FIG. 10D, which may include a graphic of several children playing, with the tagline “Find out more about the world you live in through reading” displayed below the graphic. In some embodiments, the third display screen output 1000D may display a “Done” button when the display screen displays the last display screen output of the walkthrough output.

In some embodiments, when a user has completed the walkthrough output, the application may display a registration screen output 1000E. In some embodiments, the registration screen output 1000E may provide options for a user to register for an account for himself/herself and/or his/her children, to sign in using an email account (if the user already has an account), or to sign in using a social media account (if the user already has an account), for example, the user's Facebook™, Google™, or Apple™ account. The registration screen output 1000E may also provide an option for a user to “Join as a Child.” In order to register for an account, a user may be required to provide his or her name, email address, and password in order to create an account or profile. In some embodiments, the user may be able to register using his or her account for a different social media or application provider, such as his or her Facebook™, Google™, or Apple™ account.

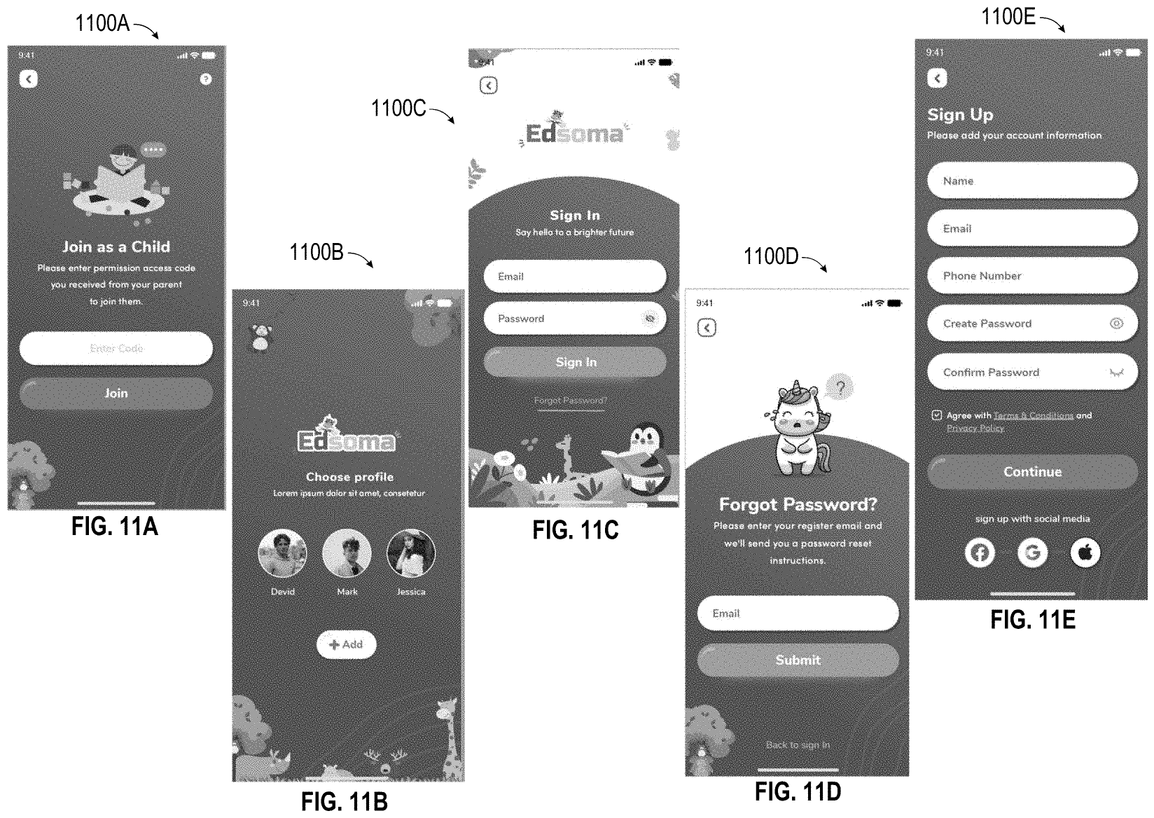

FIGS. 11A-E depict example display screen outputs 1100A-E generated by an application for evaluating and improving reading skills in real time, according to some example embodiments of the present disclosure.

In some embodiments, a parental code may be set during the registration process. The parental code may be a permission access code that a parent or adult provides to a child in order for the child to gain access to a reading session that is connected to the parent or the adult. As depicted in FIG. 11A, if the user selects the “Join as a Child” option, the application may then require the user to input the parental access code at the display screen 1100A in order for the user to join their parent in a reading session.

In some embodiments, after a user has selected a sign-in option or has input a parental access code, the display screen may display a profile selection output 1100B, as depicted in FIG. 11B. The user may select from at least one profile associated with the application. Each profile may be labeled with a name and a profile picture, and the profile selection output 1100B may provide an option for a user to add a new profile. If a user opts to sign in with an email account, a sign-in display screen output 1100C may be displayed, as depicted in FIG. 11C. The sign-in display screen output 1100C may provide data fields for a user to enter his/her email address and password, and may provide a “Sign In” button for the user to tap in order to access the account or profile after a valid email address and password combination has been entered. In some embodiments, the sign-in display screen output 1100C may also include a “Forgot Password?” option, which a user may select in order to be transitioned to a password recovery screen output 1100D, as depicted in FIG. 11D. In one embodiment, the password recovery screen output 1100D may include the tagline “Forgot Password? Please enter your register email and we'll send you a password reset instructions.” In this embodiment, the password recovery screen output 1100D may also provide a data field for the user to provide his/her email address and a “Submit” button in order to enable password recovery.

In some embodiments, if the user selects a registration or sign-up option at the registration screen output 1000E, the sign-up page 1100E may be displayed at the display screen. The user may be requested to provide a name, email address, phone number, a password, and a password confirmation in order to proceed with account registration. In some embodiments, the user may be requested to agree with the terms and conditions and the privacy policy associated with the application in order to proceed with account registration. The user may select “Continue” after the data fields have been populated with the required information. In other embodiments, the user may select the Facebook icon, the Google icon, or the Apple icon in order to use an account associated with the social media provider to complete account registration.

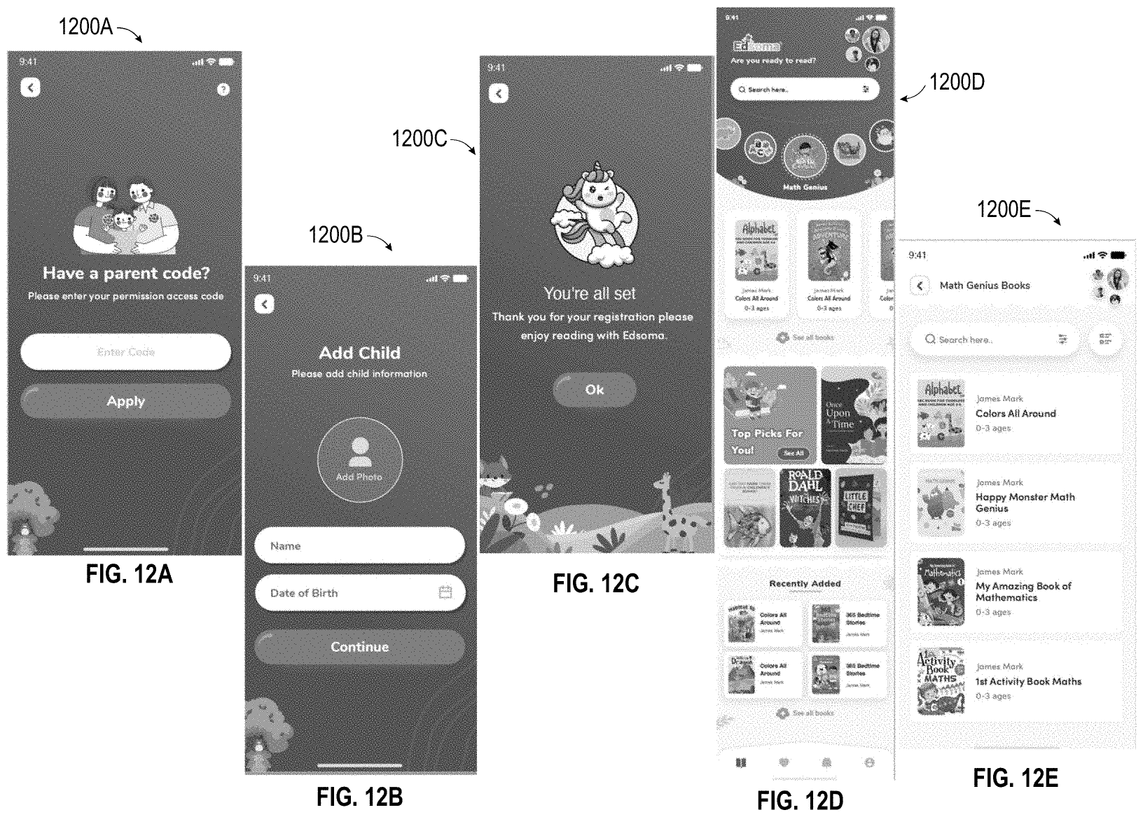

FIGS. 12A-E depict example display screen outputs 1200A-E generated by an application for evaluating and improving reading skills in real time, according to some example embodiments of the present disclosure.

In some embodiments, after registering for the user's account, the display screen may display a prompt 1200A for a parent to enter a permission access code, as displayed in FIG. 12A. The user may select the “Apply” button after the permission access code has been entered, which may then trigger the display of an “Add Child” screen output 1200B, as displayed in FIG. 12B. The “Add Child” screen output 1200B allows a parent or other adult to fill out data fields for a child's name, date of birth, and profile picture. When a parent or other adult has completed his/her profile and the profile(s) of any children connected to his/her account, a completion screen 1200C may be displayed at the display screen, as displayed in FIG. 12C. The completion screen 1200C may state “You're all set” and “Thank you for your registration please enjoy reading with Edsoma.” In some embodiments, after the user selects the “Ok” button, the display screen proceeds to display the application's home page 1200D, as displayed in FIG. 12D. For example, the home screen may include a search bar, a filter function for narrowing down the available books in the application into a specific list, a listing of various book categories, a “See all books” option, suggested books in a “Top Picks For You!” category, recently added books, and several tabs associated with various features of the user's account. For example, the application may display any combination of the following options at the bottom of the home page 1200D for navigation within the application: a home button, a “my favorites” button,” a notifications button, and a “my profile” button. The search bar may be configured to enable a user to search for books by title, author, and/or keywords. The application may be configured to return search suggestions when a user inputs a search. Additionally, the filter function may be configured to allow a user to filter books by age, language, category, and genre type (e.g., fiction versus non-fiction). If the user selects a particular category of books, the display screen may output a listing of books within that category, along with a search bar for searching out books within that category. For example, as depicted in FIG. 12E, the display screen may display a search bar and a list of options 1200E within the “Math Genius books” category. While viewing the list of options 1200E, the user may be able to view the title, author, recommended age group, and cover image of each book. In some embodiments, the list of options 1200E may include books that are available to be obtained from an open source library in order to enable free access for application users.

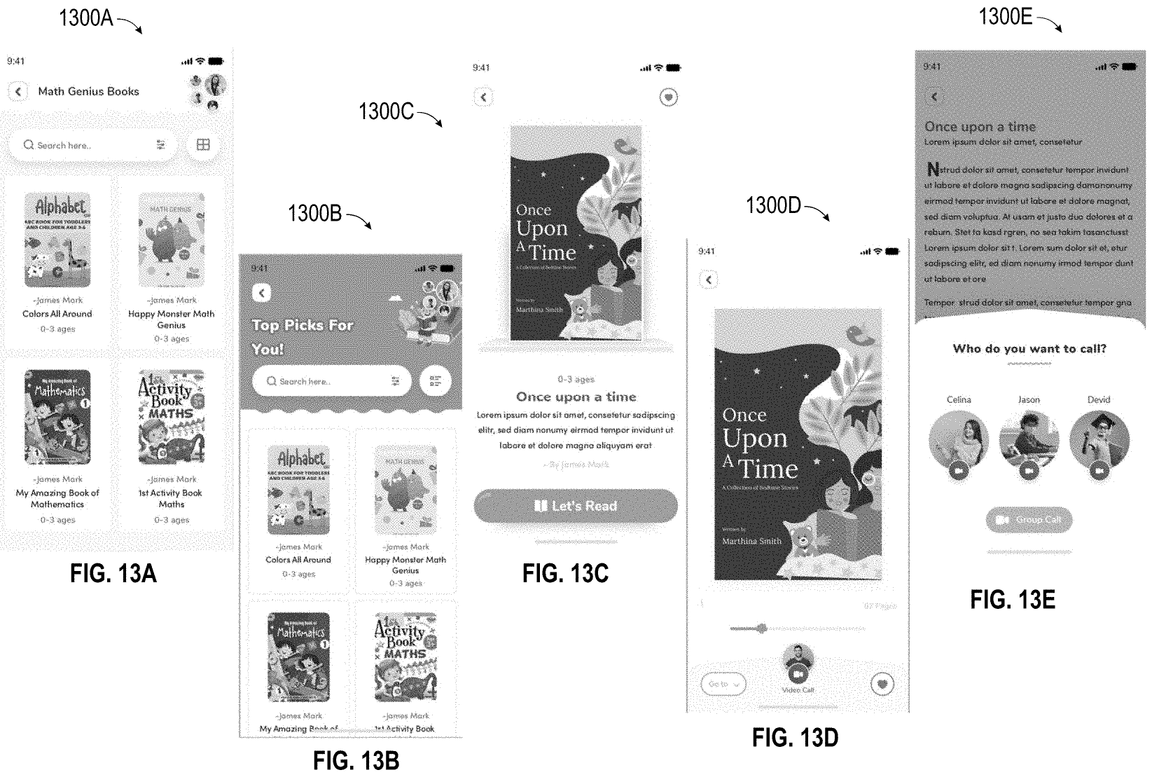

FIGS. 13A-E depict example display screen outputs 1300A-E generated by an application for evaluating and improving reading skills in real time, according to some example embodiments of the present disclosure.

Similar to FIG. 12E, FIG. 13A depicts a listing of books 1300A within a user-selected particular category of books, but displayed as a grid as opposed to a list. In some embodiments, when the user selects the “Top Picks For You!” category, the display screen may output a listing of popular books 1300B that may be of interest to the user, as depicted in FIG. 13B, and may include a search bar for the user to run a search that is constrained by the listing of popular books 1300B.

In some embodiments, as depicted in FIG. 13C, once a book has been selected by the user, a book overview display screen output 1300C may be displayed at the display screen. For example, the book overview display screen output 1300C may include a book cover, a book title, a book author, a recommended reading age associated with the book, a book category, and/or a book synopsis. The book overview display screen output 1300C may further include a “Let's Read” button for a user to initiate reading of the book. When the “Let's Read” button has been selected by a user, the display screen may transition to a video call option output 1300D, as depicted in FIG. 13D. In addition to displaying the book cover, the video call option output 1300D may further include a button for a user to initiate a video call. If the user selects the button to initiate a video call, the display screen outputs a call recipient selection output 1300E, as depicted in FIG. 13E. The call recipient selection output 1300E may provide various selectable icons to represent each potential call recipient, and may also provide a “Group Call” button to enable the user to call all the potential call recipients in a single group call. In some embodiments, if potential call recipients are not added to a call at this point in the reading session, the potential call recipients may still be added to the reading session at a subsequent point in time.

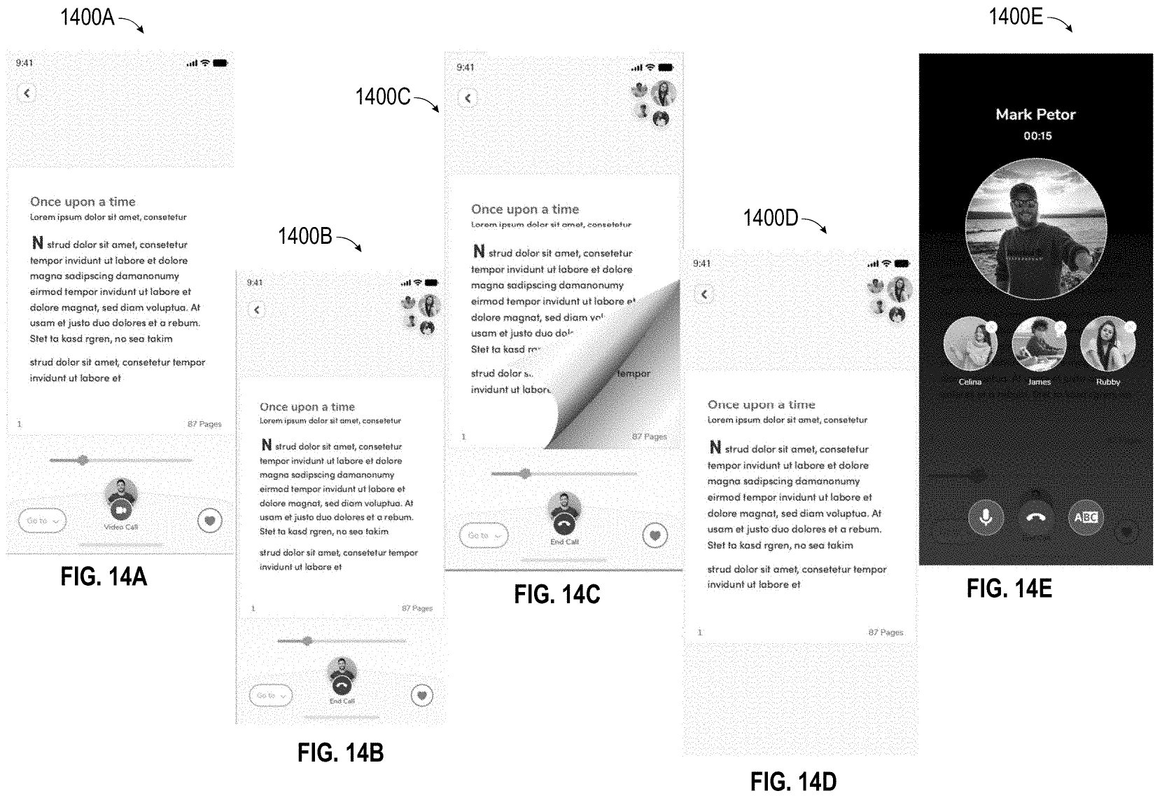

FIGS. 14A-E depict example display screen outputs 1400A-E generated by an application for evaluating and improving reading skills in real time, according to some example embodiments of the present disclosure.

In some embodiments, after the user selects a book, reading content 1400A associated with the book may be displayed at the display screen. The reading content 1400A that is displayed may be the beginning of the book (in the case of the user selecting a new book) or the last-read portion of a book (in the case of the user selecting a partially-read book). The user may have the option to initiate a video call at the bottom of the screen. The reading content 1400A may include a “like” option for the user to add the book to his/her “my favorites” list of books. Once a video call is initiated and the call recipients have been identified, the video call initiation button at the bottom of the screen may be replaced by an “End Call” button, and icons to indicate the participants of the video call may be displayed in the top right hand corner of the display screen 1400B, as depicted in FIG. 14B. As each page is read over the video call, the display screen 1400C may flip the pages of the book, as depicted in FIG. 14C. As each page of the book is flipped, a subsequent page of the book may be displayed at the display screen 1400D, as depicted in FIG. 14D. In some embodiments, a page change may be accompanied by animation to illustrate the page change. In some embodiments, when the icons indicating the participants of the video call are selected, a call display screen 1400E may be displayed, which may provide a user with the option to add or remove participants from the call, end the video call, mute himself/herself, and add or remove subtitles to the video call.

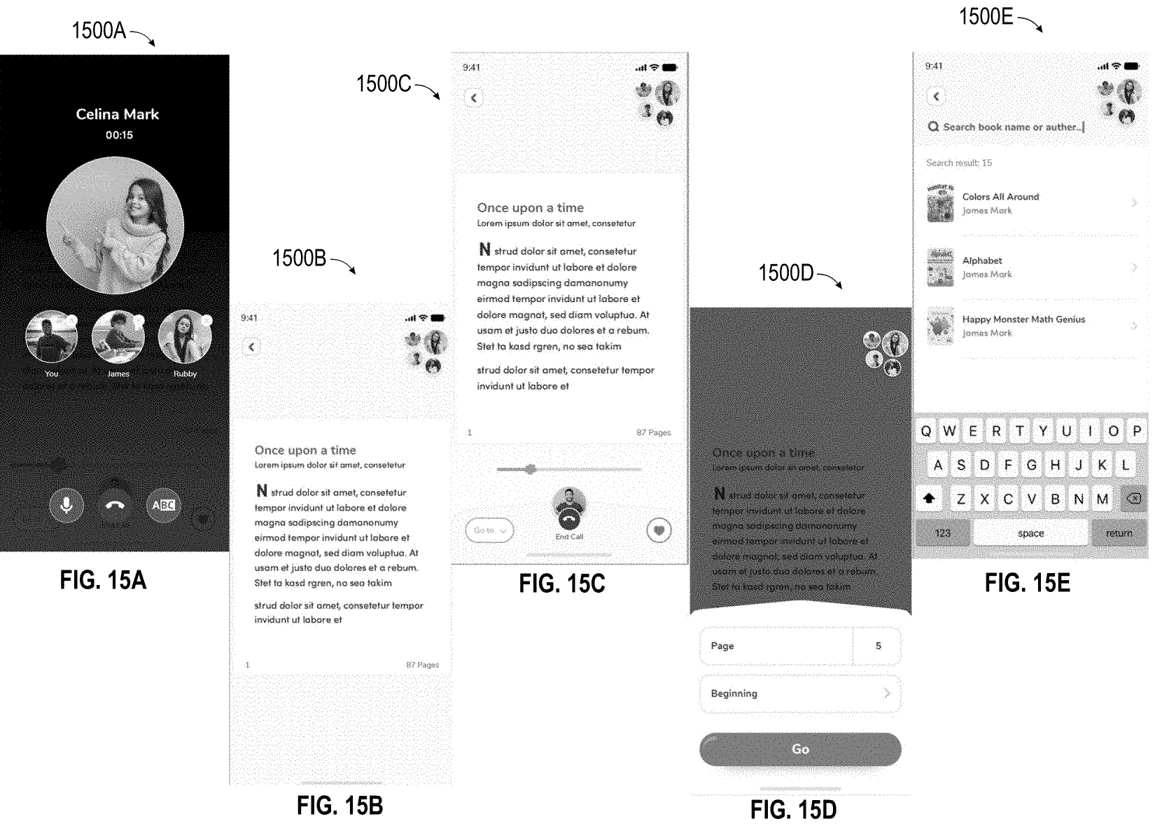

FIGS. 15A-E depict example display screen outputs 1500A-E generated by an application for evaluating and improving reading skills in real time, according to some example embodiments of the present disclosure.

As depicted in FIG. 15A, a call display screen 1500A may be configured such that the user indicated by the largest icon is the user that is currently reading out loud to the other video call participants. In some embodiments, the call display screen 1500A may be minimizable to allow the reading content 1500B to be displayed at the display screen, as depicted in FIG. 15B.

As depicted in FIG. 15C, the reading content 1500C may further include a “Go To” button. Upon selecting the “Go To” button, the display screen may provide options 1500D between inputting a page number for the reading content to move to a particular page number, and selecting the “Beginning” button for the reading content to move to the beginning of the book. The user may have to select the “Go” button before such a page change is executed. In some embodiments, when one user changes the page on the display screen during a video call, all listener(s)' user devices may also change the page being displayed on their respective display screen(s). In some embodiments, if another book is desired while the participants are engaged on the video call, a search bar 1500E can be pulled up once the call display screen has been minimized in order for the user to search for another book based on a book name and/or a book author.

In some embodiments, although not depicted in FIGS. 15A-E, the application can be configured to highlight each word in a book as the user reads each respective word to the listener(s). In some embodiments, the user may be able to turn on or turn off the text highlighting option. In some embodiments, the user may be able to toggle between a front camera and a rear camera on the user device. In some embodiments, the application may be configured to use the Agora API to support video calling functionalities.

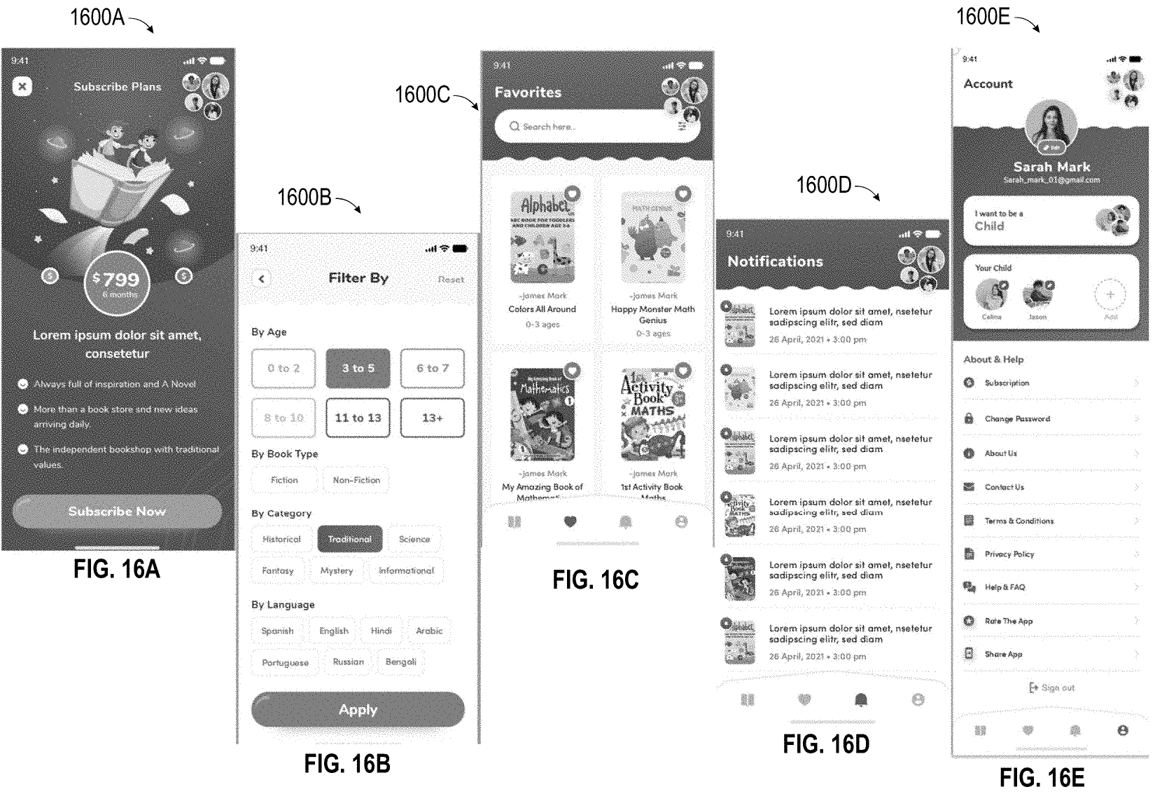

FIGS. 16A-E depict example display screen outputs 1600A-E generated by an application for evaluating and improving reading skills in real time, according to some example embodiments of the present disclosure.

As depicted in FIG. 16A, the display screen 1600A may be configured to generate a “Subscribe Now” screen to advertise a particular subscription associated with the application, with the user having an option to purchase the subscription via an in-app purchase through a button on the display screen. In some embodiments, as depicted in FIG. 16B, the display screen may allow a filter screen output 1600B to be configured to allow a user to filter books by recommended age group, a book type (e.g., fiction versus non-fiction), a category, and/or a language. When the user selects the “Apply” button, the list of filtered books may be displayed. In some embodiments, as depicted in FIG. 16C, a Favorites list 1600C associated with the user may be displayed. Each user may be able to view, add to, and remove books from the “Favorites” list 1600C. In some embodiments, the “Favorites” list 1600C may be displayed in chronological order. In some embodiments, as depicted in FIG. 16D, the user may have the option of viewing all Notifications 1600D that have been pushed to the user's account. In some embodiments, the notifications may be associated with available books. In other embodiments, the notifications may be associated with subscriptions and/or administrator notifications. In some embodiments, as depicted in FIG. 16E, the user may have his or her profile 1600E accessible through the application. The “Account” profile 1600E may display the user's name, email address, profile picture, status (e.g., a child or a parent), and family members that are associated with the user's account. In some embodiments, the user may be able to edit his/her profile from the “Account” profile 1600E display output, such as his/her linked email address, profile information, and/or listener details. In some embodiments, the “Account” profile 1600E may further include other account functionalities, including managing the user's subscription, changing the user's password, accessing software developer information through an “About Us” page, contacting the software developer, reviewing the terms and conditions associated with the application, reviewing the privacy policy associated with the application, obtaining help (at least partially through reviewing a set of frequently asked questions), rating the app, and/or sharing the app. In some embodiments, the “Account” profile 1600E may also provide a sign-out option for a user to log out of the account.

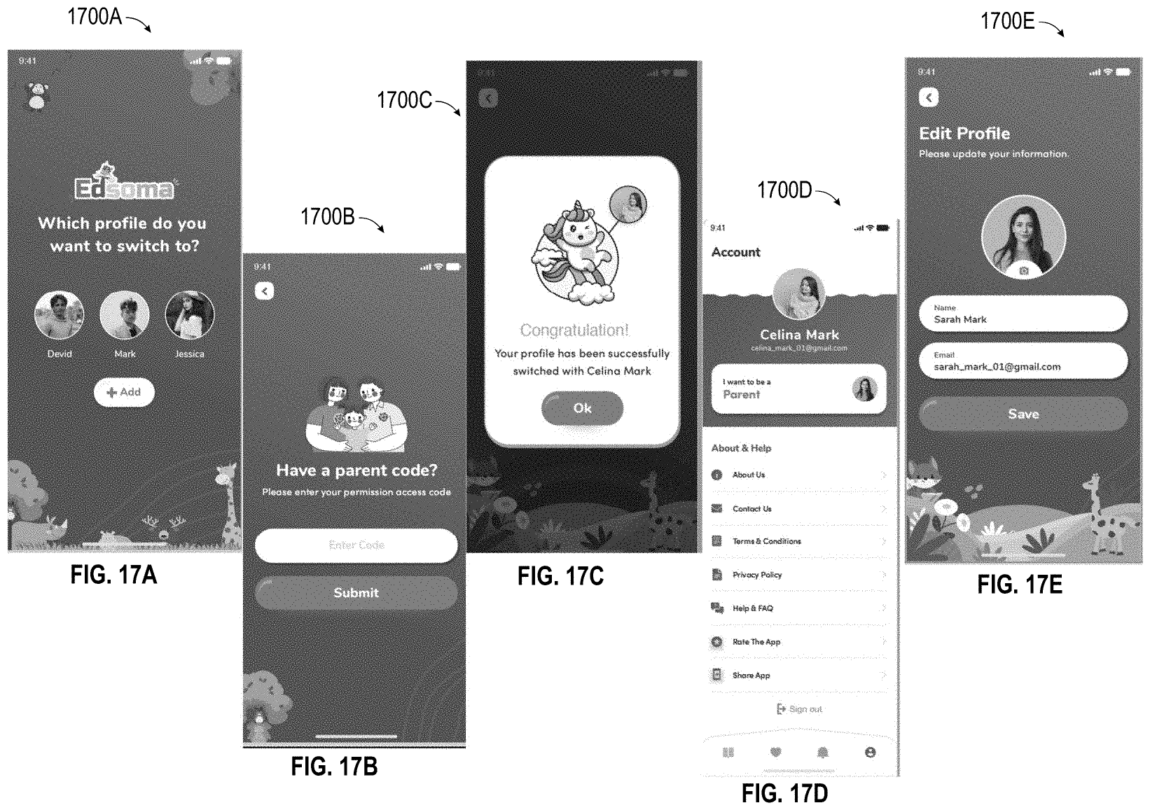

FIGS. 17A-E depict example display screen outputs 1700A-E generated by an application for evaluating and improving reading skills in real time, according to some example embodiments of the present disclosure.

As depicted in FIG. 17A, the display screen may allow for a profile switching display screen output 1700A, in which a user may have the option to switch between profiles that are associated with the user's account or to add a new profile to be switched to. In some embodiments, as depicted in FIG. 17B, switching between profiles may require a permission access code to be input at a data field on the display screen 1700B. In some embodiments, if the profile switching is successful, a “Congratulation!” screen 1700C may be output at the display screen, as depicted in FIG. 17C. In one example, as illustrated in FIG. 17D, after a user has input his/her parent code as the permission access code, the “Account” profile 1700D may reflect that the user's profile is that of a parent. Upon switching his/her profile, the display screen may prompt the user to edit his/her profile 1700E in order to update his/her name, email address, and/or profile picture, as depicted in FIG. 17E.

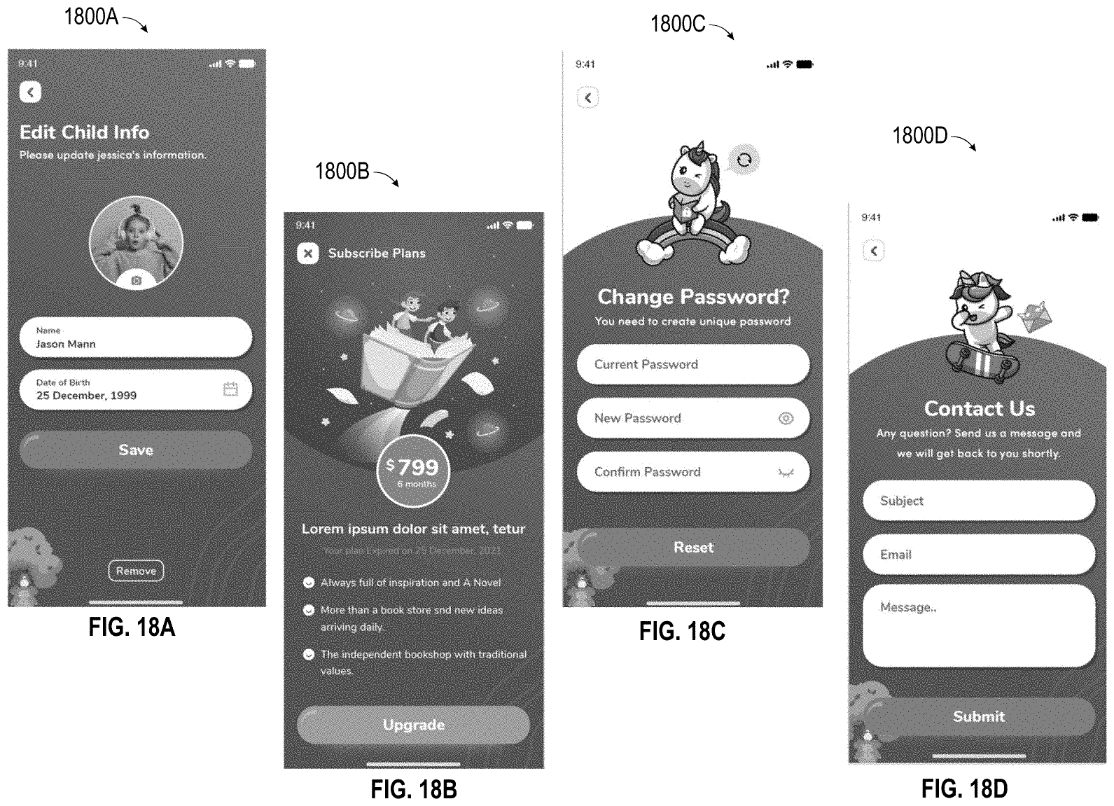

FIGS. 18A-D depict example display screen outputs 1800A-D generated by an application for evaluating and improving reading skills in real time, according to some example embodiments of the present disclosure.

In some embodiments, as depicted in FIG. 18A, a parent may have the ability to edit a child's account information 1800A directly from his/her account. The parent may have the ability to update a child's name, birthday, and/or profile picture, and to save such information to the child's account. In some embodiments, as depicted in FIG. 18B, the parent may also have the ability to upgrade his/her subscription plan 1800B through in-app purchases via a selectable button at the display screen. In some embodiments, as depicted in FIG. 18C, a user may have the option to change his/her password 1800C by populating data fields associated with a current password, a new password, and a confirmed new password. Password changes may not be propagated until the user selects the “Reset” button. In some embodiments, as depicted in FIG. 18D, the user may be able to contact the software developer through a “Contact Us” page 1800D by filling out data fields including a subject, the user's email address, and a message, and then selecting the “Submit” button.

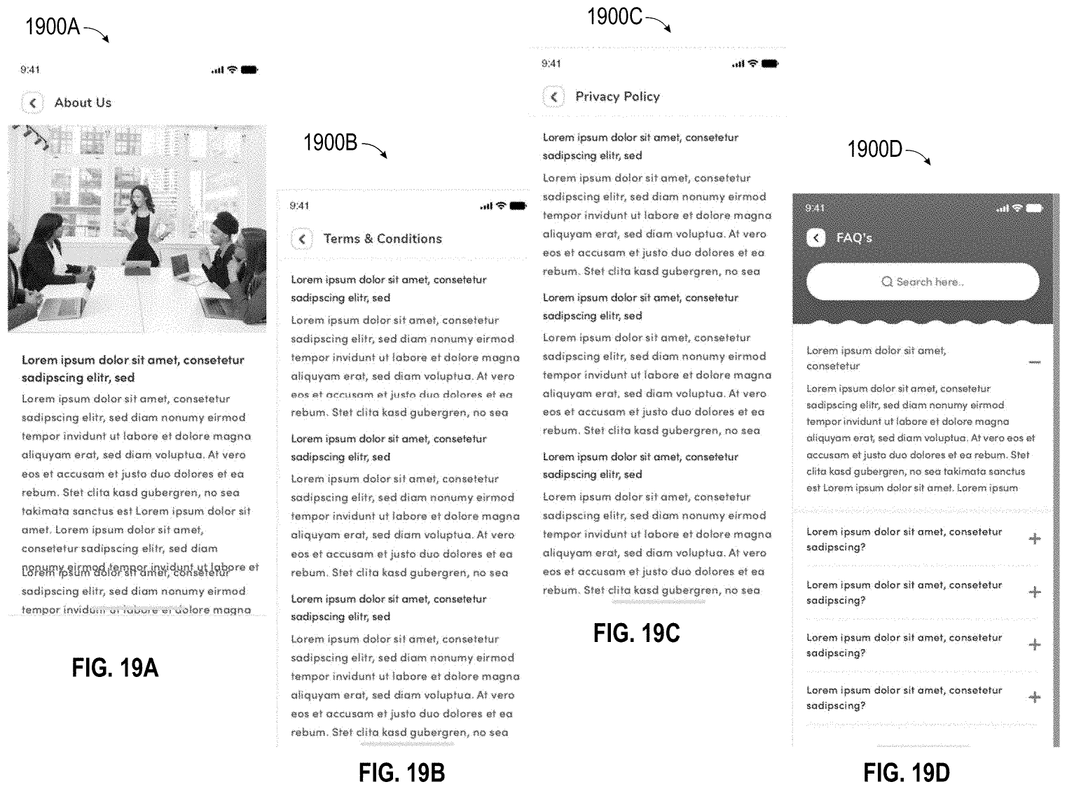

FIGS. 19A-D depict example display screen outputs 1900A-D generated by an application for evaluating and improving reading skills in real time, according to some example embodiments of the present disclosure.

In some embodiments, FIG. 19A depicts an “About Us” page 1900A to provide users with more information about the software developers. In some embodiments, FIG. 19B depicts a “Terms & Conditions” page 1900B to allow users to review the terms and conditions associated with the application. In some embodiments, FIG. 19C depicts a “Privacy Policy” page 1900C to allow users to review the privacy policy associated with the application. In some embodiments, FIG. 19D depicts a “FAQs” page 1900D to provide answers to a list of frequently asked questions. In some embodiments, the “FAQs” page 1900D may be configured with a search bar to enable users to run a search within the frequently asked questions.

In some embodiments, although not depicted in FIGS. 10A-19D, the application may be configured to recognize if a user is struggling with reading a word. If the application detects that a user is struggling with reading a word, the application may be configured to identify the word and divide the word into the syllables to assist the user. If the user continues to struggle with reading that word, the application may be configured to enunciate the word for the user. In such instances, the application may be configured to provide recommendations as to an educational application or program that may assist the user in making improvements in identified areas in which the user has encountered reading difficulties.

In some embodiments, although not depicted in FIGS. 10A-19D, the application may include an avatar to monitor any users associated with an account. The avatar may be configured to learn a user's mannerisms regarding interactions with listeners. Over time, the avatar may become capable of successfully imitating a user.

In some embodiments, although not depicted in FIGS. 10A-19D, the application may include a platform for in-application data to be shared within a predefined network. For example, a family can set up a family network, within which each family member may have access to data shared by another family member. Data on the platform may include shared stories and moments. In one embodiment, the network may be closed, such that only users within the network can access the data shared on the platform. In another embodiment, the network may be open, such that all users on the application may have access to the data shared on the platform, although data on such platforms may only involve adults.

In some embodiments, although not depicted in FIGS. 10A-19D, the application may include e-commerce functionalities operable for providing opportunities for authors, publishers, and/or users. For example, the application may offer “live” reading sessions, in which electronic book authors may be able to initiate real-time reading sessions for their books that users may participate in. The application may be configured such that those electronic book authors may receive payments from users for a reading session. In some embodiments, the application may be configured such that electronic book authors may be able to make bulk sales of their books through their “live” reading sessions.

In some embodiments, although not depicted in FIGS. 10A-19D, the application may not be limited to only books, but may also include periodicals, short stories, and/or other printed media.

In some embodiments, although not depicted in FIGS. 10A-19D, the application may provide the user with metrics associated with the user's progress in developing his/her reading skills, such as by showing historical scoring data reflective of a trend of improvement over time and/or historical reading trends associated with increasingly difficult reading content over time.

In some embodiments, although not depicted in FIGS. 10A-19D, the application may provide scores and/or metrics associated with a user as requested and/or a predefined schedule in order to identify users who may require increased attention in order to improve their reading skills. The application may also be configured to construct sets of questions that may be used to test comprehension of words and/or concepts presented by an author of a book based on the user's reading skills.

In some embodiments, although not depicted in FIGS. 10A-19D, reading content may be recommended to the user based on algorithms configured to generate user-preferred content based on reader capabilities, age-based interests, subject matter preferences, author preferences, parental or school restrictions, a frequency and velocity associated with the user, and/or any other user preferences.

In some embodiments, although not depicted in FIGS. 10A-19D, the real-time speech-to-text conversion system may be configured to improve itself over time as familiarity with the user's voice is developed.

In some embodiments, the application may be compatible with various operating software. For example, the application may be compatible with the Android™ OS, such as versions 6.0 through 10.0. The application may also be compatible with iOS™, such as versions 12.0 through 14.0. Thus, the application may support an iPhone® 6, iPhone® 6S, iPhone® 6 Plus, iPhone® 6S Plus, iPhone® 7, iPhone® 7 Plus, iPhone® 8, iPhone® 8 Plus, iPhone® X, iPhone® XS Max, iPhone® XR, or iPhone® 11. In some embodiments, an associated application programming interface (API) may be created in NodeJS. In some embodiments, the API may be in a Json format.

In other embodiments, the application may be capable of functioning as a web application. In some embodiments, the web application may be created with the Hypertext Preprocessor (PHP) framework CodeIgniter. The web application may be supported by various browsers. For example, the web application can be used on Mozilla™ Firefox™ 60.0 to 67.0, Google™ Chrome™ 65.0 to 74.0, Microsoft™ Internet Explorer™ 11.0 and Edge™, and Safari™ 11 to 12.1.1.

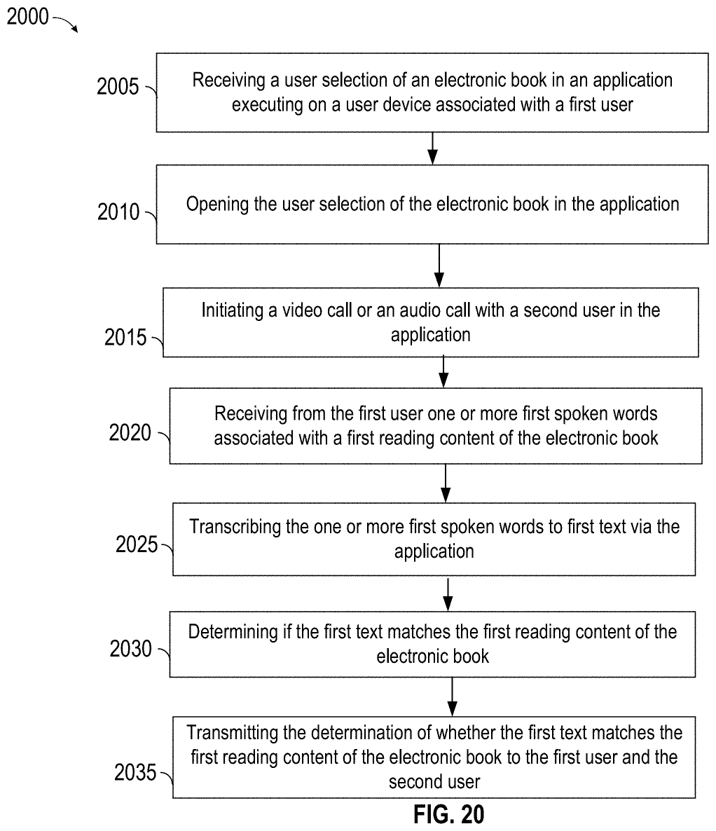

FIG. 20 is a flow chart 2000 of an example method of evaluating and improving reading skills in real time, according to some example embodiments of the present disclosure. The flow chart 2000 illustrates a sequence of operations that can be implemented in hardware, software, or a combination thereof. In the context of software, the operations represent computer-executable instructions stored on one or more non-transitory computer-readable media such as a memory that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flow chart 2000 may be carried out by a computer or mobile device either independently or in cooperation with other devices such as, for example, other computers, mobile devices and/or cloud elements.

At block 2005, a user selection of an electronic book may be received in an application executing on a user device associated with a first user. In some embodiments, the first user may be one of a child or a language student, and wherein the second user may be one of a parent, a teacher, or a language-fluent person. In some embodiments, the user selection of the electronic book may involve the requesting of a list of electronic books via a search function in the application, the receipt of the list of electronic books via the search function, and selecting the electronic book from the list of electronic books. In some embodiments, the search function is configured to allow the first user or the second user to search for the list of electronic books by at least one of a book title, an author name, or a keyword.

At block 2010, the user selection of the electronic book may be opened in the application.

At block 2015, a video call or an audio call may be initiated with a second user in the application. In some embodiments, the video call or the audio call may be initiated with the second user and a third user in the application.

At block 2020, one or more first spoken words associated with a first reading content of the electronic book may be received from the first user.

At block 2025, the one or more first spoken words may be transcribed to first text via the application.

At block 2030, it may be determined if the first text matches the first reading content of the electronic book. In some embodiments, the application may be configured to highlight the first reading content of the electronic book as the one or more first spoken words are received from the first user.

At block 2035, the determination of whether the first text matches the first reading content of the electronic book may be transmitted to the first user and the second user.

In some embodiments, one or more second spoken words associated with a second reading content of the electronic book may be received from the first user. The one or more second spoken words may be transcribed to second text via the application. It may then be determined if the second text matches the second reading content of the electronic book. The determination of whether the second text matches the second reading content of the electronic book may be transmitted to the first user and the second user.

Unless otherwise noted, the terms used herein are to be understood according to conventional usage by those of ordinary skill in the relevant art. In addition to the definitions of terms provided below, it is to be understood that as used in the specification and in the claims, “a” or “an” can mean one or more, depending upon the context in which it is used.

Throughout this application, the term “include,” “include(s)” or “including” means “including but not limited to.” Note that certain embodiments may be described relating to a single user device, but the corresponding description should be read to include embodiments of two or more user devices. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems and methods that, individually and in combination, permit the evaluating and improving reading skills in real-time. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

1. A method for evaluating and improving reading skills in real-time, comprising:
receiving a user selection of an electronic book in an application executing on a user device associated with a first user;
opening the user selection of the electronic book in the application;
initiating a video call or an audio call with a second user in the application;
receiving from the first user one or more first spoken words associated with a first reading content of the electronic book;
transcribing the one or more first spoken words to first text via the application;
determining if the first text matches the first reading content of the electronic book; and
transmitting the determination of whether the first text matches the first reading content of the electronic book to the first user and the second user.

2. The method of claim 1, wherein the first user is one of a child or a language student, and wherein the second user is one of a parent, a teacher, or a language-fluent person.

3. The method of claim 1, further comprising:
receiving from the first user one or more second spoken words associated with a second reading content of the electronic book;
transcribing the one or more second spoken words to second text via the application;
determining if the second text matches the second reading content of the electronic book; and
transmitting the determination of whether the second text matches the second reading content of the electronic book to the first user and the second user.

4. The method of claim 1, further comprising:
initiating the video call or the audio call with the second user and a third user via the application.

5. The method of claim 1, wherein the application is configured to highlight the first reading content of the electronic book as the one or more first spoken words are received from the first user.

6. The method of claim 1, wherein receiving the user selection of the electronic book in the application further comprises:
requesting a list of electronic books via a search function in the application;
receiving the list of electronic books via the search function; and
selecting the electronic book from the list of electronic books.

7. The method of claim 6, wherein the search function is configured to allow the first user or the second user to search for the list of electronic books by at least one of a book title, an author name, or a keyword.

8. A system for evaluating and improving reading skills in real-time, comprising:
a user device associated with a first user executing an application configured to:
receive a user selection of an electronic book;
open the user selection of the electronic book;
initiate a video call or an audio call with a second user;
receive from the first user one or more first spoken words associated with a first reading content of the electronic book;
transcribe the one or more first spoken words to first text;
determine if the first text matches the first reading content of the electronic book; and
transmit the determination of whether the first text matches the first reading content of the electronic book to the first user and the second user.

9. The system of claim 8, wherein the first user is one of a child or a language student, and wherein the second user is one of a parent, a teacher, or a language-fluent person.

10. The system of claim 8, wherein the application is further configured to:
receive from the first user one or more second spoken words associated with a second reading content of the electronic book;
transcribe the one or more second spoken words to second text;
determine if the second text matches the second reading content of the electronic book; and
transmit the determination of whether the second text matches the second reading content of the electronic book to the first user and the second user.

11. The system of claim 8, wherein the application is further configured to:
initiate the video call or the audio call with the second user and a third user.

12. The system of claim 8, wherein the application is further configured to:
highlight the first reading content of the electronic book as the one or more first spoken words are received from the first user.

13. The system of claim 8, wherein the application is further configured to:
request a list of electronic books via a search function;
receive the list of electronic books via the search function; and
select the electronic book from the list of electronic books.

14. The system of claim 13, wherein the search function is configured to allow the first user or the second user to search for the list of electronic books by at least one of a book title, an author name, or a keyword.

15. A device comprising:
a memory that stores computer-executable instructions; and
a processor configured to access the memory and execute the computer-executable instructions to at least:
receive a user selection of an electronic book in an application associated with a first user;
open the user selection of the electronic book in the application;
initiate a video call or an audio call with a second user in the application;
receive from the first user one or more first spoken words associated with a first reading content of the electronic book;
transcribe the one or more first spoken words to first text via the application;
determine if the first text matches the first reading content of the electronic book; and
transmit the determination of whether the first text matches the first reading content of the electronic book to the first user and the second user.

16. The device of claim 15, wherein the first user is one of a child or a language student, and wherein the second user is one of a parent, a teacher, or a language-fluent person.

17. The device of claim 15, wherein the processor is further the memory and execute additional computer-executable instructions to at least:
receive from the first user one or more second spoken words associated with a second reading content of the electronic book;
transcribe the one or more second spoken words to second text via the application;
determine if the second text matches the second reading content of the electronic book; and
transmit the determination of whether the second text matches the second reading content of the electronic book to the first user and the second user.

18. The device of claim 15, wherein the processor is further configured to access the memory and execute additional computer-executable instructions to at least:
initiate the video call or the audio call with the second user and a third user via the application.

19. The device of claim 15, wherein the application is configured to highlight the first reading content of the electronic book as the one or more first spoken words are received from the first user.

20. The device of claim 15, wherein the processor is further configured to access the memory and execute additional computer-executable instructions to at least:
request a list of electronic books via a search function in the application;
receive the list of electronic books via the search function; and
select the electronic book from the list of electronic books.
